(19) United States
(12) Patent Application Publication
(10) Pub. No.: US 2004/0007219 A1
(43) Pub. Date: Jan. 15, 2004

(54) Power generation device

(76) Inventor: Katsumi Asada, Yokohama (JP)

Correspondence Address: CONNOLLY BOVE LODGE & HUTZ LLP, SUITE 800, 1990 M STREET NW, WASHINGTON, DC, 20036-3425, US

(21) Appl. No.: 10/464,451

(22) Filed: Jun. 19, 2003

(30) Foreign Application Priority Data
Jun. 19, 2002 (JP) 2002-179068

(51) Int. Cl. F02M 25/07

(52) U.S. Cl. 123/568.11

(57) ABSTRACT

To provide a practical and quite novel power generation device that is suitable for the mass-production with high productivity in an extremely low cost manner and with a high energy efficiency and a structure in view of the circumstances of the compact, light-weight and high power, a power generation system comprising an automotive turbocharger having a turbine rotated by a gas flow of exhaust gas and a compressor provided coaxially with the turbine and rotated by rotation of the turbine for compressing and feeding sucked air, a combustion device for mixing the sucked air compressed and fed by the compressor and fuel together and igniting and burning the mixture, a portion for introducing exhaust gas of the combustion device to the turbine to rotate the turbine by the gas flow of exhaust gas, and an output rotary shaft rotated by the turbine and provided to the compressor on the intake air side whereby a power generation device is rotated by the rotation of the output rotary shaft to generate an electric power.

### BACKGROUND OF THE INVENTION

1. Field of the Invention

The present invention relates to a power generation device that is suitable for use in, for example, a hybrid vehicle or the like.

2. Description of the Prior Art

A compact, high power generation device is a device for causing high temperature and high pressure gas to work to rotary vanes (a turbine) and for converting thermal energy of the gas into energy for shaft rotational motion. A compressor provided coaxially with a gas turbine for absorbing and compressing the air is rotated when the high temperature and high pressure gas rotates the gas turbine, thereby effectively utilize the energy.

However, a thermal efficiency of the gas turbine power generation device is not so good by itself For this reason, it is necessary to introduce thereinto another system for enhancing the total efficiency such as a co-generation system or a composite cycle utilizing radiated heat. In the case where these systems are utilized, it is sure that the energy efficiency is considerably enhanced but an extremely large amount of cost is required for the introduction of these systems, and in addition, the overall system is large in size. Accordingly, in this case, the merit of the compactness and the high power output is lost.

Furthermore, in a huge system such as a power generation station, even if the cost therefor is temporarily required, from the long period standpoint, it is possible to obtain the profit above the cost due to the enhanced efficiency. Accordingly, in view of the cost performance, it is possible to use the above-described expensive system. However, in the gas turbine power generation device that is compact and less expensive, even if the energy efficiency is improved, the obtained profit is small, which is extremely inferior in cost performance. In this case, it is difficult to use the expensive system. Accordingly, the compact power generation device having the high energy efficiency has not been extensively used because of the failure of the low cost in spite of the strong demand.

### SUMMARY OF THE INVENTION

In view of the foregoing situation, according to the present invention, on the basis of novel and quite unique concept to provide a combustion device used in, for example, a jet engine to a compact and less expensive automotive turbocharger extensively and generally used, the automotive turbocharger that has already been used extensively is utilized without any substantial work and manufactured to thereby make it possible to realize the enhancement in energy efficiency by reuse of heat (energy) due to the utilization of exhaust gas of the turbocharger, and the enhancement in fuel consumption rate and the low public pollution feature due to the high combustion efficiency of the combustion device in an extremely less expensive and easy manner in comparison with the conventional similar device, in addition, the combustion device is used to thereby attain the light weight, the compactness and the high power output, and low quality fuel such as kerosene may be used to thereby provide a practical and quite novel power generation device that has a high energy efficiency with a structure in view of the circumstances of the compactness, light weight and high power output and that is extremely less expensive and suitable for mass production with excellent productivity.

According to the present invention, there is provided a power generation system comprising an automotive turbocharger having a turbine rotated by a gas flow of exhaust gas and a compressor provided coaxially with the turbine and rotated by rotation of the turbine for compressing and feeding sucked air, a combustion device for mixing the sucked air compressed and fed by the compressor and fuel together and igniting and burning the mixture, a portion for introducing exhaust gas of the combustion device to the turbine to rotate the turbine by the gas flow of exhaust gas, and an output rotary shaft rotated by the turbine and provided to the compressor on the intake air side whereby a power generation device is rotated by the rotation of the output rotary shaft to generate an electric power.

Also, in the power generation system according to the above described aspect, according to a second aspect of the invention, an intake air discharge portion for compressing and feeding the sucked air by the air compressor and an intake air introduction portion of the combustion device are connected to each other, an exhaust gas discharge portion of the combustion device and an exhaust gas introduction portion to the turbine are coupled with each other, the combustion device is provided to the automotive turbocharger, and the output rotary shaft is provided to the compressor on the intake air side of the automotive turbocharger provided with the combustion device.

Also, in the power generation system according to the second aspect of the invention, according to a third aspect of the invention, a plurality of intake air discharge portions for compressing and feeding the sucked air by the compressor are provided, a plurality of exhaust gas introduction portions to the turbine are provided, the intake air discharge portions and the intake air introduction portions of the combustion device are coupled with each other, and the exhaust gas introduction portions and the exhaust gas discharge portions of the combustion device are coupled to each other so that a plurality of combustion device portions of the combustion device are provided to the automotive turbo charger.

### BRIEF DESCRIPTION OF THE DRAWINGS

FIG. 1 is a schematic illustration of an embodiment of the present invention.

FIG. 2 is an enlarged view of the present embodiment.

FIG. 3 is a schematic view of the present embodiment.

### MODE FOR EMBODYING THE INVENTION

A best mode for embodying the invention (how to embody the invention) will now be briefly described showing resultant effects on the basis of the drawings.

A power generator 6 that also serves as a starter motor is started by an electric power accumulated in, for example, a storage battery so that a compressor 2 on an air intake side is rotated to absorb the air.

The sucked air becomes high pressure gas compressed by the rotation of the compressor 2, which is fed to an intake air introduction portion 8 of a combustion device 3 through an intake air discharge portion 7.

For example, a fuel injection valve and a sparkplug are provided in an intake air introduction portion 8 of the combustion device to mix the high pressure gas compressed by the compressor 2 and atomized fuel together and to ignite the mixture to burn the fuel. A turbine 1 on the exhaust gas side is rotated by the high temperature and high pressure burnt gas with high energy to thereby rotate an output rotary shaft 5 provided on the compressor 2 coaxial with the turbine to rotate the generator 6 to output the electric power.

In this case, since the turbine 1 and the compressor 2 are provided on the same shaft 4, the compressor 2 is rotated by the rotation of the turbine 1 rotated by the exhaust gas to thereby suck and compress the air.

Namely, due to the rotation, the compressor 2 for sucking and compressing the air is rotated by the rotation of the turbine 1 rotated by the gas flow of the exhaust gas to utilize the exhaust gas to thereby enhance the energy efficiency.

Also, the sucked air pressurized and fed by the compressor 2 is mixed with the fuel in the intake air introduction portion 8 of the combustion device 3 to thereby sufficiently atomize and ignite the mixture so that the surface area of the fuel is increased to extremely enhance the fuel combustion efficiency to thereby prevent the incomplete combustion and to enhance the fuel consumption rate to finally lead to the low public pollution.

Also, the combustion device 3 is used to realize the compactness and light weight with the large power output. Also, it is possible to use low quality fuel such as kerosene so that the flexibility of selection of the fuel is improved, which is quite practical.

Also, the output rotary shaft 5 is provided on the compressor 2 on the intake air side which is the low temperature side so that it is unnecessary to impart the durability against the high temperature to the output rotary shaft 5. Accordingly, it is possible to attain the low cost feature with high reliability.

Furthermore, according to the present invention, since the above-described combustion device 3 and output rotary shaft 5 are simply provided to the automotive turbocharger A that has a well known mass-productive structure and that may be produced in a mass-production manner in low cost, it is possible to provide the high power and high efficiency power generation device in extremely low cost, which is superior in mass-production and compact in size and light in weight.

Namely, if the high power and high efficiency are attained so far, the overall system is more expensive. In this case, the mass-productivity is lost, and it is practically impossible to provide a compact and less expensive system. However, according to the present invention, the combustion device is provided to the turbocharger (super charger) to thereby make it possible to attain the high power and high efficiency. In addition, the automotive turbocharger A is used as the super charger to thereby make it possible to provide the power generation device that is superior in mass-productivity in extremely low cost.

Also, since the output rotary shaft 5 is not provided on the high temperature side on the turbine 1 side but on the low temperature side on the compressor 2 side (on the intake air side), the reliability is enhanced and the much easier structure may be attained to thereby attain the further less expensive feature.

Also, it is quite easy to provide the combustion device 3 and the output rotary shaft 5 to the automotive turbocharger A. It is therefore possible to extremely easily manufacture the system and in addition, it is possible to use the well known mass-productive product without any special work for the automotive turbocharger A. Accordingly, with the structure to provide the combustion device 3 and the output rotary shaft 5 to the automotive turbocharger A, it is possible to provide the power generation device that is compact in size and light in weight with the high output power and may realize the high output power and high efficiency with the excellent mass-productivity in a less expensive manner that might not been imagine so far.

Accordingly, according to the present invention, it is possible to provide a practical and quite novel power generation device that is suitable for the mass-production with high productivity in an extremely low cost manner and with a high energy efficiency and a structure in view of the circumstances of the compact, light-weight and high power.

For example, in the case where the present invention is applied to a prime mover for a hybrid vehicle, it is possible to manufacture the highbred vehicle with the feature of compactness and light weight, low public pollution, low fuel consumption and high power. Accordingly, since it is possible to attain, in extreme low cost, the output to the same extent as that by a general micro gas turbine generator as a compact and high power electric power generator, it is possible to utilize a sales point that the generator is low in cost and high in output power, which has not been attained by the conventional hybrid vehicle. It is possible to expect that the novel generator may be used in a more extensive field than the conventional one. Therefore, the present invention may be most suitably applied to the prime mover of the hybrid vehicle.

### DESCRIPTION OF THE EMBODIMENTS

A specific embodiment will now be described with reference to the accompanying drawings.

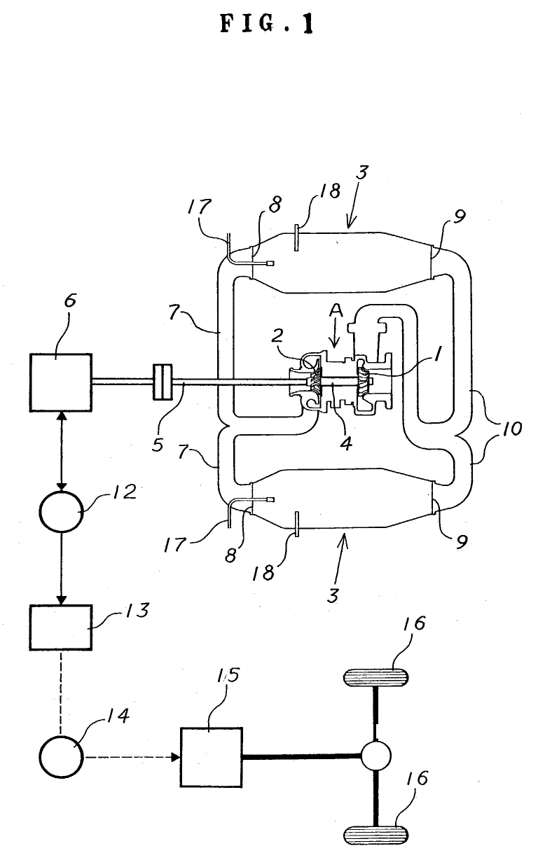

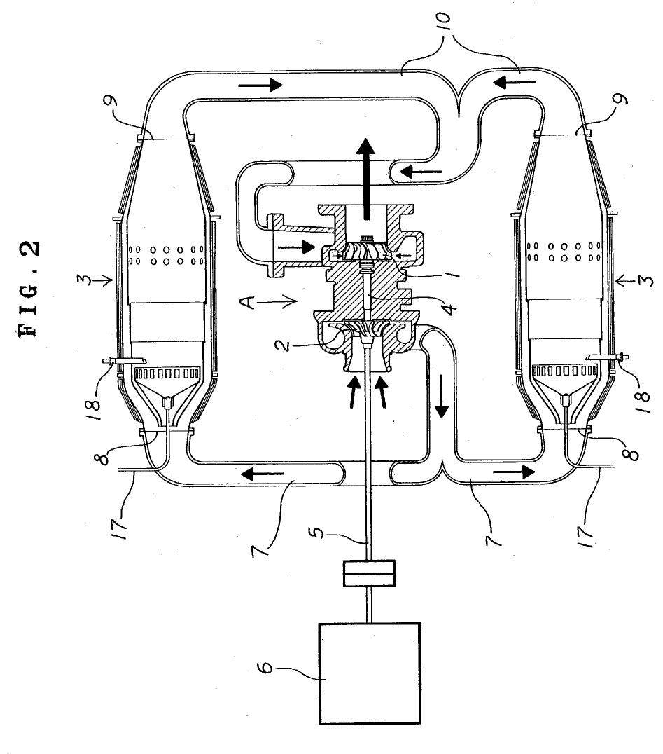

As shown in FIGS. 1 to 3, in the embodiment of the invention, an automotive turbocharger A provided with a turbine 1 that is rotated by a gas flow of exhaust gas and a compressor 2 that is provided in the same shaft 4 as the turbine 1 and rotated by the rotation of the turbine 1 to compress and feed the sucked air is used. Each combustion device 3 for mixing the sucked air compressed and fed by the above-described compressor 2 and fuel together and for ignite and burn the mixture is provided to introduce the exhaust gas of the combustion device 3 into the above-described turbine 1 to rotate the turbine 1 by the gas flow of the exhaust gas. An output rotary shaft 5 to be rotated by this turbine 1 is provided to the above-described compressor 2 on the intake air side to rotate a power generator 6 by the rotation of this output rotary shaft 5 to thereby output the electric power..

To describe each portion more specifically, in an automotive turbocharger A that has been extensively used, the turbine 1 is rotated by the exhaust gas, this turbine 1 drives the compressor 2 to provide the air more than a regular amount to the engine, a large amount of fuel is burnt correspondingly to increase the power. An exhaust gas introduction portion 10 for introducing the exhaust gas from the engine into the turbine 1 and an intake air discharge portion 7 for feeding the intake air compressed by the compressor 2 to the engine are provided in this automotive turbocharger A.

The turbine 1, the compressor 2 and the shaft 4 provided in the automotive turbocharger A are used without any modification.

A hollow cylinder is used as the combustion device 3. One end portion of an opening portion of the combustion device 3 is used as an intake air introduction portion 8. The other end portion is used as an exhaust gas discharge portion 9. A fuel injection valve 17 and a sparkplug 18 for mixing and burning the sucked air compressed and fed and the atomized fuel are provided in this intake air introduction portion 8.

Also, the intake air discharge portion 7 of the automotive turbocharger A and the intake air introduction portion 8 of the combustion device 3 are connected to each other and the exhaust gas introduction portion 10 of the automotive turbocharger A and the exhaust gas discharge portion 9 of the combustion device 3 are coupled with each other to thereby make it possible to mount the combustion device 3 to the automotive turbocharger A. Accordingly, it is unnecessary to work the automotive turbocharger A by using the turbocharger that is available on the market and it is extremely easy to perform the mounting work for mounting the combustion device 3 to the automotive turbocharger A to thereby make it possible to facilitate the manufacturing work. Accordingly, in this embodiment, the present invention ensures the structure that is extremely superior in mass-productivity.

Also, in this embodiment, the two combustion devices 3 are symmetrically provided but it is possible to provide a plurality of combustion devices 3 in an annular arrangement around the automotive turbocharger A. In this case, it is possible to attain the further compact structure.

Also, in order to provide the plurality of combustion devices 3, it is necessary to take a structure in which a plurality of intake air discharge portions 7 and a plurality of exhaust gas introduction portions 10 be provided in the automotive turbocharger A. In this embodiment, the single intake air discharge portion 7 and the single exhaust gas introduction portion 10 provided to the automotive turbocharger A are branched on the way for the plurality of combustion devices 3. For example, it is possible to take a structure of the provision of the plurality of combustion devices 3 by providing the plurality of intake air discharge portions 7 and the plurality of exhaust gas introduction portions 10 to the automotive turbocharger A.

The output rotary shaft 5 is provided to the compressor 2 on the intake air side. The intake air side is highly reliable since the intake air side is kept at a low temperature and stable and different from the exhaust gas side that is kept at an extremely high temperature. Also, since it is unnecessary to make the output rotary shaft 5 of special material that is durable against the heat and durable against the high temperature, the output rotary shaft 5 may readily be made in low cost.

Also, since almost all the parts that might work as obstacles are removed from the portion around the compressor 2 in order to enhance the efficiency of the sucked air when the output rotary shaft 5 is to be mounted on the compressor 2, there are no obstacles at all against the mounting operation and there are no work. Accordingly, the mounting operation may readily be attained.

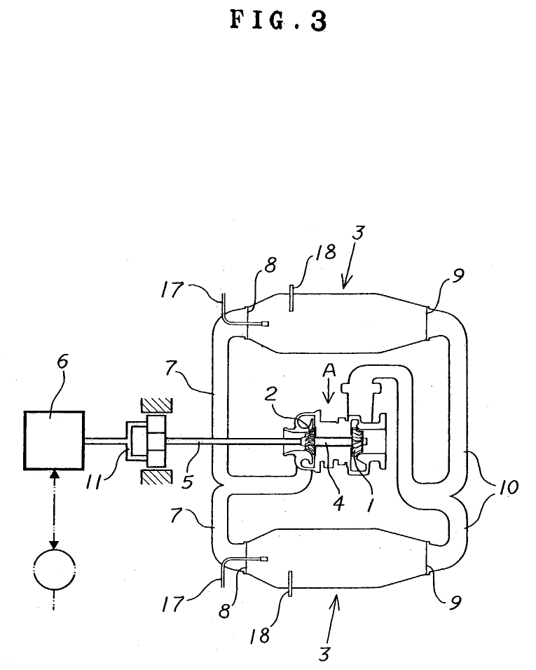

In this embodiment, the output rotary shaft 5 is connected directly to the compressor 2 on the intake air side but it is possible to interpose a speed reduction device 11 (such as a planetary gear system, a multiple gear system, a friction drive system and the like) as shown in FIG. 3.

Also, in this embodiment, if the generated electric power is larger than that required for travel, the electric power generated from the generator 6 is stored in a storage battery 13 in accordance with a controller 12, and in the case where the electric power is insufficient to that required for travel, the electric energy from the storage battery 13 is transmitted to a motor 15 for driving wheels 16 in accordance with a controller 14 for controlling the feed of electric energy to the motor 15 for driving the wheels 16 from the storage battery 13 to make it possible to use the system as the prime mover for the hybrid vehicle.

The case where this embodiment is applied to the prime mover of the hybrid vehicle as described above will be explained as follows.

In the most cases, the prime mover of the vehicle actually traveling is driven at a rpm rate of about 60% and a load rate of about 50%. The output zone of the prime mover for the vehicle using the automotive turbocharger is set at the output corresponding to such rates (at a design point). In this embodiment, the prime mover is almost always operated at this design point.

In the case where the load exceeds the design point, since the output according to this embodiment is insufficient, the output of the storage battery is used simultaneously.

In the case where the load is around the design point, only the output of this embodiment is used.

In the case where the load is smaller than the design point, the output of the embodiment is greater than the electric power to be used for travel and the power corresponding to its extra difference is stored in the storage battery.

Accordingly, in this embodiment, the output may be set at a level smaller than the maximum output required for the vehicle and the system is operated always at the constant load and the rpm to thereby make it possible to improve the fuel consumption rate.

Since the embodiment is structured as described above, it is possible to ensure the following advantages.

It is possible to dispense with a cooling device (such as a cooling water pump, a radiator, a cooling fan or the like) used in a gasoline engine or a diesel engine to thereby enhance the reliability.

Since oil for lubricating the turbocharger is used also for the oil for the engine, it is unnecessary to use the contaminated oil such as blow-by gas of the engine to thereby prolong the service life of the turbocharger.

In the case where the engine is turbo-supercharged, in some cases, an air cooler is used in a midway of the air intake system for enhancing the performance or processing the exhaust gas. This may be dispensed with.

The turbocharger may be operated at the design point (at a high efficiency point) to thereby improve the fuel consumption rate.

Since the turbocharger is available on the market on the mass-production basis. It is possible to provide the turbocharger in low cost.

It is possible to enhance the working rate of the production line of the turbocharger.

The turbocharger may correspond to a variety of kinds of fuel to thereby make it possible to enhance the flexibility.

This system may be reduced in weight and size in comparison with the conventional gasoline or diesel engine. Accordingly, in the case where the system is applied to the vehicle, it is free to adopt a desired layout. In particular, the front shape of the vehicle is usually limited by the engine mounting space, but it is possible to increase the flexibility of the design of the vehicle by using this system.

Accordingly, according to the present invention, it is possible to provide a practical and quite novel power generation device that is suitable for the mass-production with high productivity in an extremely low cost manner and with a high energy efficiency and a structure in view of the circumstances of the compact, light-weight and high power.

For example, in the case where the present invention is applied to a prime mover for a hybrid vehicle, it is possible to manufacture the hybrid vehicle with the feature of compactness and light weight, low public pollution, low fuel consumption and high power. Accordingly, since it is possible to attain, in extreme low cost, the output to the same extent as that by a general micro gas turbine generator as a compact and high power electric power generator, it is possible to utilize a sales point that the generator is low in cost and high in output power, which has not been attained by the conventional hybrid vehicle. It is possible to expect that the novel generator may be used in a more extensive field than the conventional one. Therefore, the present invention may be most suitably applied to the prime mover of the hybrid vehicle.

What is claimed is:

1. A power generation system comprising an automotive turbocharger having a turbine rotated by a gas flow of exhaust gas and a compressor provided coaxially with said turbine and rotated by rotation of the turbine for compressing and feeding sucked air, a combustion device for mixing the sucked air compressed and fed by said compressor and fuel together and igniting and burning the mixture, a portion for introducing exhaust gas of said combustion device to said turbine to rotate said turbine by the gas flow of exhaust gas, and an output rotary shaft rotated by said turbine and provided to said compressor on the intake air side whereby a power generation device is rotated by the rotation of said output rotary shaft to generate an electric power.

2. The power generation system according to claim 1, wherein an intake air discharge portion for compressing and feeding the sucked air by said air compressor and an intake air introduction portion of said combustion device are connected to each other, an exhaust gas discharge portion of said combustion device and an exhaust gas introduction portion to said turbine are coupled with each other, said combustion device is provided to said automotive turbocharger, and said output rotary shaft is provided to said compressor on the intake air side of said automotive turbocharger provided with said combustion device.

3. The power generation system according to claim 2, wherein a plurality of intake air discharge portions for compressing and feeding the sucked air by said compressor are provided, a plurality of exhaust gas introduction portions to said turbine are provided, said intake air discharge portions and said intake air introduction portions of said combustion device are coupled with each other, and said exhaust gas introduction portions and said exhaust gas discharge portions of said combustion device are coupled to each other so that a plurality of combustion device portions are provided to said automotive turbo charger.
